(19) United States
(12) Patent Application Publication
(10) Pub. No.: US 2024/0411434 A1
(43) Pub. Date: Dec. 12, 2024

(54) System and Method of Displaying Major Information of Web Pages

(71) Applicant: Zifu Wang, Kenmore, WA (US)

(72) Inventor: Zifu Wang, Kenmore, WA (US)

(21) Appl. No.: 18/668,160

(22) Filed: May 18, 2024

Related U.S. Application Data
(60) Provisional application No. 63/503,486, filed on May 21, 2023.

(51) Int. Cl. G06F 3/0484; G06F 3/0487; G06F 40/14

(52) U.S. Cl. CPC G06F 3/0484; G06F 3/0487; G06F 40/14; G06F 2203/04806

(57) ABSTRACT

This disclosure presents a system and method for optimizing the display of major information on web pages. It identifies key elements such as the title, main content, author, and publication date, dynamically merging these into an “original area.” This area is then fitted into a user-selected or predefined “target area” using advanced zooming and repositioning techniques. The method significantly enhances readability by removing non-essential elements like ads, navigation menus, and other distractions. Various determination methods are employed, including user configurations, known selector matching, external services, and machine learning models. The system is designed to be flexible and can be implemented as either a browser extension or a built-in browser feature. It offers both manual and automatic operation modes, allowing users to customize their viewing experience and maintain focus on the most relevant content, thereby improving overall user engagement and satisfaction.

### CROSS-REFERENCE TO RELATED APPLICATIONS

This application claims the benefit of U.S. Provisional Patent Application No. 63/503,486, filed on May 21, 2023.

### FIELD OF THE DISCLOSURE

The present disclosure pertains to the field of user interfaces, and more specifically, to methods for displaying the primary information on web pages.

### BACKGROUND OF THE DISCLOSURE

As the capabilities of browser technologies and the World Wide Web infrastructure expand, browsers are increasingly becoming the primary access point for a vast array of content and applications. Despite this progress, the design of many web documents still requires them to host multiple content elements intended for diverse functionalities. This often leads to an information overload for users, diverting their attention with non-essential elements such as navigation controls, user interface elements, and various marketing or advertising campaigns, which detract from their engagement with the intended core content. In response to these challenges, browser developers have implemented a feature known as ‘reader mode.’ This functionality is engineered to enhance the readability of web content by eliminating superfluous components like advertisements and navigational elements, thus isolating and displaying only the essential text and images. Furthermore, several third-party browser extensions have emerged, offering similar capabilities.

In essence, the ‘reader mode’ provided by these browsers and extensions serves as an effective tool to streamline the presentation of web content, significantly improving user focus on relevant information. When activated, ‘reader mode’ conducts an analysis of the web page to determine the main content areas. Subsequently, it generates a streamlined version of the page, applying custom CSS to remove non-essential elements, thereby facilitating a more focused and less cluttered user experience.

### Drawbacks of Reader Mode

Content Identification Issues:
Browsers and their extensions equipped with reader mode function by extracting information to construct a new, independent webpage or by overlaying new elements onto the existing webpage to mask the original content, herein referred to as NEW WEBPAGE. However, this process can lead to inaccuracies in identifying the main content and may inadvertently omit critical elements. Consequently, the NEW WEBPAGE might fail to encapsulate all essential information or eliminate all extraneous content.

esign Integrity Compromise:
Effective website design requires meticulous attention to page layout, color schemes, font choices, images, and videos to optimize visual appeal, usability, and readability. Despite these considerations, NEW WEBPAGE often fails to preserve the original design elements, which can sometimes make the content difficult to read or interact with. For instance, as illustrated in FIG. 1, Firefox Reader Mode often does not maintain the original CSS properties of the web page, leading to potential loss of design continuity and aesthetic appeal.

Traditional web browsers also offer zooming capabilities, such as using keyboard shortcuts (e.g., Ctrl−+), to enhance the visibility of web page content. However, these methods generally scale the entire layout uniformly, leading to several issues. First, such zooming can disrupt the original layout of the web page, making it difficult to navigate and interact with. Second, this approach indiscriminately enlarges all page elements, including non-essential parts such as navigation bars, which may not be relevant to the user's current focus. This not only distracts from the main content but also consumes additional screen space, thereby diminishing the overall user experience.

There is a clear need for a more intelligent system that can dynamically optimize the display of web content based on its significance, focusing on enhancing the visibility of essential information without altering the underlying page structure or unnecessarily enlarging less relevant sections

### SUMMARY OF THE DESCRIPTION

The present disclosure relates to systems and methods of displaying the major information of web pages. This may be implemented by identifying the elements that represent the main information of a web page, merging the areas occupied by these elements to generate an area (hereinafter referred to as ORIGINAL AREA) and fitting the area they occupy to a user-selected area or a predefined area if the user does not configure (hereinafter referred to as TARGET AREA). In one embodiment, the predefined area is the viewport.

The elements that contain the following information are often considered to be the building elements of the main information: major content, title of web page, author, date published, and the like. These elements hereinafter are referred to as CONTENT ELEMENT, TITLE ELEMENT, AUTHOR ELEMENT, and DATE ELEMENT respectively.

The fitting comprises two operations: zooming in and repositioning. The width of TARGET AREA is usually wider than the width of ORIGINAL AREA, so the zooming in will fit ORIGINAL AREA to TARGET AREA.

Repositioning will align the top of ORIGINAL AREA with the top of TARGET AREA. This will render the unrelated content invisible from TARGET AREA.

By zooming in and repositioning the area that covers the elements that represent the main content of the webpage, distracting elements such as ads, navigation menus, and the like are effectively placed outside of the TARGET AREA and viewport. This has the effect of making text easier to read.

In one embodiment, the present disclosure employs a combination of three methods each to determine CONTENT ELEMENT and TITLE ELEMENT, hides elements with position property set to “fixed” or “sticky” and display property set to “block”, and then merges the areas of CONTENT ELEMENT and TITLE ELEMENT to generate ORIGINAL AREA, and finally fits ORIGINAL AREA to TARGET AREA using the scale CSS function and the translate CSS function on the BODY element.

In one embodiment, the present disclosure employs a combination of three methods each to determine TITLE ELEMENT, hides elements with position property set to “fixed” or “sticky” and display property set to “block”, and then takes the area of TITLE ELEMENT as ORIGINAL AREA, and finally fits ORIGINAL AREA to TARGET AREA using the scale ( ) CSS function and the translate ( ) CSS function on the BODY element.

FIG. 2 demonstrates the effect of applying the discloser on a web page. The upper part in FIG. 2 shows the original web page, the lower part shows the web page after applying the disclosure.

### BRIEF DESCRIPTION OF THE DRAWINGS

The present disclosure is illustrated by the accompanying drawings, which serve as examples and are not intended to restrict the scope of the disclosure.

FIG. 1 illustrates that browser reader modes and analogous browser extensions do not retain the original CSS of webpages. The left portion of FIG. 1 is the original webpage; the right portion is the page generated by Firefox Reader Mode based on the same webpage.

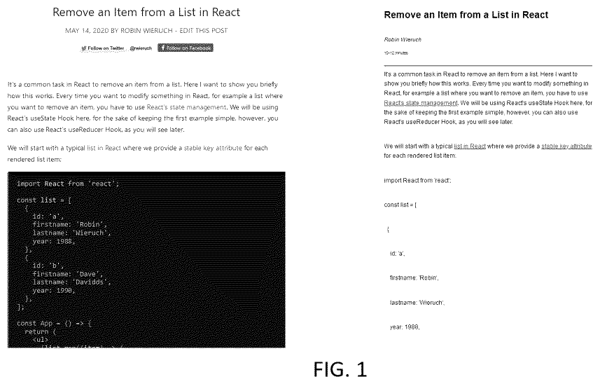

FIG. 2 illustrates a specific web page after the disclosure is applied. The upper portion is the original web page; the lower portion is the web page after applying the disclosure.

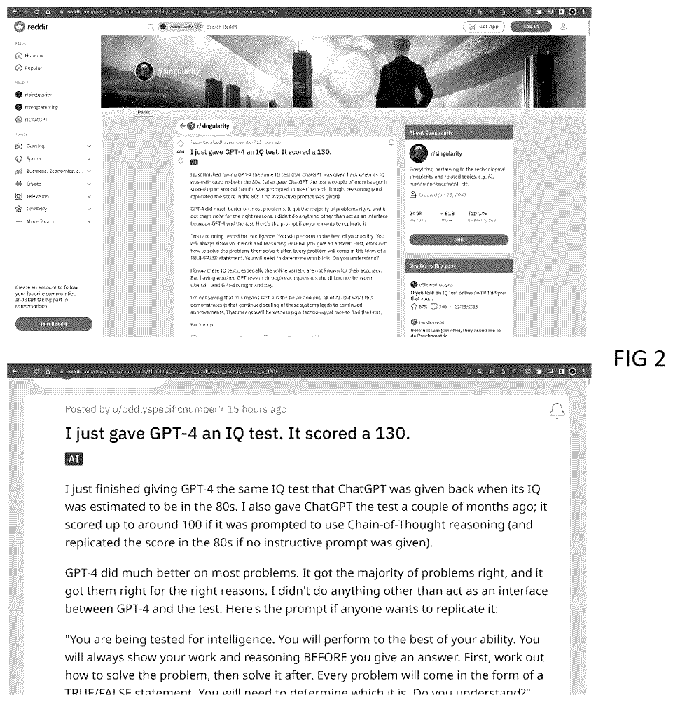

FIG. 3 is a flow diagram illustrating one embodiment of a process to determine CONTENT ELEMENT and TITLE ELEMENT, exclude white space in CONTENT ELEMENT and TITLE ELEMENT, and merge the areas of CONTENT ELEMENT and TITLE ELEMENT to generate ORIGINAL AREA, which is then fitted to TARGET AREA.

FIG. 3.1 is a flow diagram illustrating one embodiment of a process to determine TITLE ELEMENT.

FIG. 3.2 is a flow diagram illustrating one embodiment of a process to determine CONTENT ELEMENT.

FIG. 3.3 is a flow diagram illustrating one embodiment of a process to merge the areas of TITLE ELEMENT and CONTENT ELEMENT.

FIG. 3.4 is a flow diagram illustrating one embodiment of a process to fit ORIGINAL AREA to TARGET AREA.

FIG. 3.5 is a flow diagram illustrating an embodiment of a process for determining the TITLE ELEMENT.

FIG. 3.6 is a flow diagram illustrating an embodiment of a process for determining the CONTENT ELEMENT.

FIG. 4 is a sample diagram illustrating sample user interfaces, including manual user selection of CONTENT ELEMENT.

FIG. 5 is a flow diagram illustrating an embodiment of employing a combination of different approaches to determine the ORIGINAL AREA.

FIG. 6 shows an example of a webpage viewed in high resolution

### DETAILED DESCRIPTION

When the specification mentions “one embodiment,” “an embodiment,” or “another embodiment,” it signifies that a specific feature, structure, or characteristic described in association with that embodiment may be incorporated into one or more embodiments of the disclosure. It is important to note that the instances of the phrase “in one embodiment” found in different parts of the specification may not necessarily pertain to the same embodiment.

Each website has its own unique layout, varying in page structure, typography, colors, font selection, and the inclusion and placement of pictures and videos. For instance, news sites often have a three-column layout that separates articles, images, and navigation menus to make it easier for readers to find what interests them; e-commerce sites often use a layout which includes a product listing and category menu so that customers may browse and purchase products.

Many simple websites utilize a single layout for each of their web pages. In contrast, more complex sites may use multiple layouts for different pages. The two most common ways in which web pages within a single website may differ are:
Webpages under different subdomains may use different layouts.
Webpages under different paths (e.g., “/blogs/”, “/news/”, etc.) may use different layouts.

In some particularly large websites, both approaches may be used simultaneously.

Elements in a web page may be identified using a number of identifiers, including:
XPath
CSS selector
jQuery selector
unique ID
unique name
unique class name(s)s
unique attribute(s)

The elements associated with these identifiers can be retrieved using their corresponding functions. These optional functions include, but are not limited to: getElementByID, getElementsByClassName, getElementByName, querySelector, querySelectorAll, document.evaluate, and other similar variants.

### Determination of CONTENT ELEMENT

In one embodiment, CONTENT ELEMENT is determined by the predefined and user configured element identifier. Users may select the element that they believe to be CONTENT ELEMENT. This method hereinafter is referred to as CONTENT ELEMENT METHOD1.

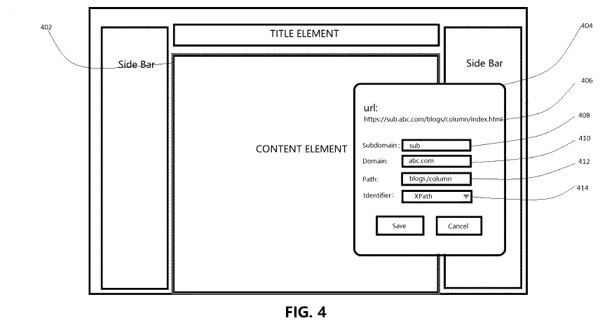

CONTENT ELEMENT METHOD1 may be varied through the implementation of different user interfaces. FIG. 4 is a sample diagram illustrating sample user interfaces including selecting CONTENT ELEMENT by users. A user chooses element 402, indicated with a red border, as CONTENT ELEMENT, and the configuration dialog 404 shows all information available to edit. The label 406 is the URL of the current web page; text box 408 contains the subdomain of the web page “sub.” If all subdomains have the same layout, text box 408 may be cleared. The domain field 410 is a label and cannot be changed. Text box 412 contains the full path. If all paths have the same layout, text box 412 may be cleared. If a layout is only used in a specific path, text box 412 may be edited to reflect this. Identifier 414 is an editable combo box that contains all possible unique identifiers, and, for example, allows users to simplify the XPath identifier.

In one embodiment, even if different layouts exist for various subdomains and/or paths within a domain, only the domain of a web page is considered when determining CONTENT ELEMENT. Element identifiers of a user-defined CONTENT ELEMENT are saved to an array for that domain. Consequently, any element on a web page under a specific domain that matches any element saved in the corresponding array for that domain is identified as a CONTENT ELEMENT

Collecting the element identifiers of CONTENT ELEMENT for popular websites may improve both performance and accuracy. These identifiers may be used as pre-defined data for the system, either as a part of the system or downloaded from the web.

In one embodiment, CONTENT ELEMENT is determined by searching for the element that matches special selectors that are known to match CONTENT ELEMENT, may include, but is not limited to “div.article details”, “div.entry-content”, or “div.single-blog_content”. If the web page contains only one element that matches one of these known selectors, the element is taken as CONTENT ELEMENT. If more than one element is found, the first element found may either be taken as CONTENT ELEMENT or as a mistake and ignored. Additional checks may be performed to ensure the accuracy of the identified CONTENT ELEMENT, such as verifying its visibility and ensuring that its width and height exceed predetermined thresholds. This method hereinafter is referred to as CONTENT ELEMENT METHOD2.

When determining the CONTENT ELEMENT or TITLE ELEMENT, many methods iterate from the BODY or HTML element (as seen with CONTENT ELEMENT METHOD3) or rely on the features or content of the BODY or HTML element (as seen with CONTENT ELEMENT METHOD6). In such cases, the BODY or HTML element is referred to as the BEGINNING element. However, under different circumstances, other elements can also serve as the BEGINNING element. For instance, in CONTENT ELEMENT METHOD3, an element with the <main>tag is used as the BEGINNING element instead of the BODY or HTML element. Alternatively, the BEGINNING element can be selected using any other available known selectors, if they exist. This approach often enhances performance and reduces the likelihood of false positives.

In one embodiment, the element determined by the known selectors may be used as the BEGINNING element of other methods instead of regarding as CONTENT ELEMENT directly.

In one embodiment, CONTENT ELEMENT is determined through external services. The services may return a unique element identifier for given URL or HTML content and the element identifier is used to get the element.

External services, as referred to here, include but are not limited to the following:
1. third-party services
2. self-built services,

In one embodiment, CONTENT ELEMENT is determined using ML models or JavaScript libraries.

The ML model or JavaScript libraries may return a unique element identifier for a given URL or HTML content which may then be used to get the element.

Given the URL, HTML content, or text content of web page, the ML model or JavaScript libraries may return what it deems the primary content of the web page, which may then be used to find the element that contains it.

Given URL or HTML content of the web page, the ML model or JavaScript libraries may return the HTML of the element it deems to contain the primary content of the page, which may then be used to find CONTENT ELEMENT by finding the element that contains the HTML.

Given the URL or HTML content of the web page, the ML model or JavaScript libraries may directly return the element identifier (e.g., XPath) of the CONTENT ELEMENT.

In one embodiment, CONTENT ELEMENT is determined by finding the element whose ratio of the length of the text within the element to the length of all text on the page exceeds a predefined threshold. This may only check elements that with special tag names, may include, but is not limited to, elements such as “DIV” and “ARTICLE”

In one embodiment, CONTENT ELEMENT is determined according to the proportion of the occupied area of the element. This is accomplished by iteratively determining the element within a parent element that occupies the largest area and descending layer by layer until no such element exists; this final element is taken as CONTENT ELEMENT. This method hereinafter is referred to as CONTENT ELEMENT METHOD3.
1. Create an empty ELEMENT PATH array to keep the elements at each level.
2. Choose an element of the web page as the start point and set it as the element to process (thereafter refer as CURRENT LEVEL ELEMENT). Usually, it is the BODY element of the web page, but it may be some special element.
3. Check all of child elements of CURRENT LEVEL ELEMENT. If the ratio of the area of a child element to its own area exceeds a predefined threshold, append the child element to the ELEMENT PATH array, and set it as CURRENT LEVEL ELEMENT and repeat this step until no such a child element may be found and the loop ends. The ELEMENT PATH array will hold the elements that occupy a significant enough area at each level. The last element in ELEMENT PATH array is CONTENT ELEMENT.

Although it is common to start processing from the BODY element, it is possible to speed things up by starting with a specific element. Some candidates for this include elements with “MAIN” tag, elements assigned the “main” role ([role=main]), or elements with an id property of “main”. This method is not entirely reliable and requires some form of validation: for example, whether an element is too far from the top of the web page.

The area of an element can be calculated using the following formula: (scrollWidth+margin-left+margin-right) * (scrollHeight+margin-top+margin-bottom). ScrollWidth and scrollHeight may be substituted with other similar attributes, such as offsetWidth and offsetHeight, or equivalent attributes

You may find the margin sizes of an element by first calling the getComputedStyle function to get the element's computed style, and then calling getPropertyValue function to get the value of each margin.

While searching for CONTENT ELEMENT, some elements may be excluded, may include but is not limited to elements with the tags “SCRIPT”, “STYLE”, “LINK”, “NOSCRIPT”, and “META”.

It is also possible to exclude certain semantic elements, such as “HEADER”, “ASIDE”, “NAV”, or “FOOTER”; but this is not completely reliable. Because website designers do not always adhere to the indented purposes of semantic tags, some websites place the primary content of their web page within a semantic tag (such as in a sub-element of the <header>element). Additional checks may be conducted to enhance the accuracy of the determined CONTENT ELEMENT.

It is also possible to exclude elements with certain class names, such as “sidebar” or “sticky-wrap-sidebar-col”, or specific IDs, such as “sidebar” or “navigation”, which are known or likely to be navigation elements

It is also feasible to exclude elements where the distance between one of their edges and the corresponding edge of the BODY element exceeds a predefined threshold, such as half the width of the BODY element. For left-to-right (LTR) webpages, this pertains to the left edge, whereas for right-to-left (RTL) webpages, it pertains to the right edge.

Elements may also be excluded if the distance between their top edge and the top of either the identified TITLE ELEMENT or, if not identified, the viewport exceeds a predefined threshold

Elements whose width does not exceed a predefined threshold, such as one-third of the width of the viewport, may also be excluded.

An element may mainly contain navigation hyperlinks without being tagged with a semantic tag such as “ASIDE” or “NAV”. In this case, the process may check whether the element is actually a navigation element; if it is, it is eliminated from consideration for CONTENT ELEMENT.

An element may be taken to be a navigation element if:
1. the ratio of the text length of all <a>elements to the entire element text exceeds a predefined threshold
2. the ratio of the number of <a>child elements of the element to all terminal child elements exceeds a predefined threshold

If a child element has “absolute” position property and takes up a significant area but there is a subsequent element with “static” position property, this element may not be a candidate for CONTENT ELEMENT and may be excluded.

In addition, while determining the element, an element may be taken as CONTENT ELEMENT even if it possesses child elements which exceed the predefined threshold in size if:
1. the child element is too far away from the top or title element of the web page (if the title element has been determined). This often indicates the existence of a large child element of the content element.
2. multiple text elements (for example, <p>elements) appear in the child elements of the element.
3. the height of the element does not exceed a predefined threshold
4. the element contains too little text

In one embodiment, CONTENT ELEMENT is determined according to the proportion of the inner text of the element. This is very similar to CONTENT ELEMENT METHOD3. The only difference is that this method checks whether the ratio of the amount of inner text of a child element to the amount of its own inner text of exceeds a predefined threshold. This method hereinafter is referred to as CONTENT ELEMENT METHOD4.

If the element is a shadow host or contains a child element that is a shadow host, then the “innerText” or “textContent” property of an element may not return the text it contains. Therefore, it is necessary to check whether the element is a shadow host and whether it has child elements that are shadow hosts. In any case, it is necessary to obtain the “innerText” or “textContent” property of all the elements contained in the shadow host object and combine them to form the overall inner text of the element.

In one embodiment, the CONTENT ELEMENT is determined based on its features. This method is hereinafter referred to as CONTENT ELEMENT METHOD 5. The process may be conducted through the following steps:
1. Collect Potential Elements: Gather elements with tags that could be CONTENT ELEMENTs, such as “div,” “article,” “section,” and similar tags. This is best performed by selecting all elements with these tags at once, rather than gathering all elements of each tag independently.
2. Apply Constraints to Filter Elements: Evaluate each collected element against the following constraints:
   The element should not be invisible or obscured by elements with a higher z-index.
   The element's position property should not be “absolute,” “sticky,” or “fixed.”
   The distance between the top edge of the element and the top of the viewport should be within a predefined threshold.
   For an LTR web page, the left edge of the element should be to the left of the left edge of the BODY; for an RTL web page, the right edge of the element should be to the right of the right edge of the BODY.
   The height of the element should exceed a predefined threshold.
   The width of the element should exceed a threshold, such as one-third of the width of the BODY element.
   The amount of text content in the element should exceed a predefined threshold, or it should contain a large image.
   The number of descendants of the element should exceed a predefined threshold.
3. Select the CONTENT ELEMENT: From the list of elements that meet the filter requirements, choose the CONTENT ELEMENT using the following method:
   Initialize “left” and “right” with the positions of the left and right edges, respectively, of the last element in the list.
   Check each element in the list sequentially:
      If the distance between the left edge of the current element and “left” exceeds a predefined threshold (e.g., 50 px) and the left edge of the current element is further to the left than “left,” then the next element after the current element is taken as the CONTENT ELEMENT. Otherwise, update “left” to the position of the left edge of the current element.
      Similarly, if the distance between the right edge of the current element and “right” exceeds a predefined threshold (e.g., 50 px) and the right edge of the current element is further to the right than “right,” then the next element after the current element is taken as the CONTENT ELEMENT. Otherwise, update “right” to the position of the right edge of the current element.

In one embodiment, the CONTENT ELEMENT is determined based on the lengths of text within elements on the page. This method is hereinafter referred to as CONTENT ELEMENT METHOD 6. The process may be conducted through the following steps:
1. Determine the BEGINNING ELEMENT: Identify the BEGINNING ELEMENT using known content selectors, which may include specific tags such as “main,” specific IDs such as “main,” or specific roles such as “main.” If no specific element is found, the process begins at the BODY element.
2. Find the Longest Text Element: Locate the <p>element with the longest “innerText” or “textContent” under the BEGINNING ELEMENT identified in step 1.
3. Verify Text Proportion: Check whether the proportion of the total text contained within the BEGINNING ELEMENT that is within the <p>element found in step 2 exceeds a predefined threshold. If it does not, perform the same check on its parent element, traversing up to the BEGINNING ELEMENT if necessary.

In one embodiment, the steps taken to determine the CONTENT ELEMENT are similar to those in CONTENT ELEMENT METHOD 5. The only difference is that this method compares the number of words within an element to a root element instead of the length of the text. This method is hereinafter referred to as CONTENT ELEMENT METHOD 7.

In one embodiment, if an element matches special selectors that are known to identify a CONTENT ELEMENT, as in CONTENT ELEMENT METHOD 2, the element is not directly taken as the CONTENT ELEMENT. Instead, it is considered as the root upon which CONTENT ELEMENT METHOD 3, CONTENT ELEMENT METHOD 4, or CONTENT ELEMENT METHOD 5 may be applied to identify the CONTENT ELEMENT within the element.

In one embodiment, the CONTENT ELEMENT is determined based on its position using the following steps:
1. Identify a point that belongs to the CONTENT ELEMENT with an X-coordinate given by body.left+(body.width/2) and a Y-coordinate given by (body.top+body.height) * k, where k is any value between ½ and 1, such as ¾.
2. Retrieve the element that contains the identified point.
3. If the width of the element is smaller than a predefined threshold, examine its parent element.
4. Repeat step 3 until the width of the current element being examined is at least equal to the threshold.

The element identified in step 4 is considered a part of the CONTENT ELEMENT. This element may then be combined with the TITLE ELEMENT to generate the ORIGINAL AREA. This method is hereinafter referred to as CONTENT ELEMENT METHOD 8.

Additional steps may then be taken to determine the entirety of the CONTENT ELEMENT. This method is hereinafter referred to as CONTENT ELEMENT METHOD 9. The process involves the following steps:
1. Set the value of “left” to the position of the left edge of the element, and the value of “right” to the position of the right edge of the element.
2. If the parent element's left and right values are very close to the previously set values, examine its parent element.
3. Repeat step 2 until the examined element's parent element's left or right values significantly differ from the initial left and right values.
4. Examine the sibling element that directly precedes the examined element. If its left and right values are very close to the previously set values, examine that sibling element and include it as part of the CONTENT ELEMENT.
5. Repeat step 4 until the examined element's left or right values significantly differ from the initial left and right values.
6. Examine the sibling element that directly follows the element identified in step 3. If its left and right values are very close to the previously set values, examine that sibling element and include it as part of the CONTENT ELEMENT.
7. Repeat step 6 until the examined element's left or right values significantly differ from the initial left and right values.

### Determination of TITLE ELEMENT

In one embodiment, TITLE ELEMENT is determined by the predefined and user-configured element identifier. This is analogous to CONTENT ELEMENT METHOD1. This method hereinafter is referred to as TITLE ELEMENT METHOD1.

In one embodiment, TITLE ELEMENT is determined by searching for the element that matches special selectors that are known to match TITLE ELEMENT, may include, but is not limited to: “h1.blog-entry-title”, “h1.elementor-heading-title”, “h1.main-entry-title”, “h1.title-article”, and “header.post-info_title”. If the web page contains only one element that matches one of these known selectors, the element is taken as CONTENT ELEMENT. If more than one element is found, the first element found may either be taken as TITLE ELEMENT or as a mistake and ignored. Additional checks may be performed to ensure the accuracy of the determined TITLE ELEMENT, such as verifying its visibility and ensuring that its width and height exceed predetermined thresholds. This is analogous to CONTENT ELEMENT METHOD2. This method hereinafter is referred to as TITLE ELEMENT METHOD2.

In one embodiment, elements determined by known selectors may be used as the BEGINNING element, upon which other methods for determining the TITLE ELEMENT may be applied, instead of being taken directly as the TITLE ELEMENT. This method is hereinafter referred to as TITLE ELEMENT METHOD3

In one embodiment, TITLE ELEMENT is determined through external services. The services may return a unique element identifier for given URL or HTML content and the element identifier is used to get the element. This method hereinafter is referred to as TITLE ELEMENT METHOD4.

In one embodiment, TITLE ELEMENT is determined using ML models or JavaScript libraries. This method hereinafter is referred to as TITLE ELEMENT METHOD5.

The ML model or JavaScript libraries may return a unique element identifier for a given URL or HTML content, which may then be used to get the element.

Given the URL, HTML content, or text content of web page, the ML model or JavaScript libraries may return what it deems the title of the web page, which may then be used to find the element that contains it.

Given URL or HTML content of the web page, the ML model or JavaScript libraries may return the HTML of the element it deems to contain title of the page, which may then be used to find TITLE ELEMENT by finding the element that contains the HTML.

Given the URL or HTML content of the web page, the ML model or JavaScript libraries may directly return the element identifier (e.g., XPath) of the TITLE ELEMENT.

In one embodiment, TITLE ELEMENT is determined based on element tags, element content and the title of the web page. This method hereinafter is referred to as TITLE ELEMENT METHOD6. Whether an element is a title element may be determined by comparing the text of elements with a specific tag with the title of the web page.
1. Get the page title from the <title>element. The title may also be found in <meta>elements.
2. Search for elements with heading tags, such as “H1” through “H6”, “STRONG”, and the like; and compare the text of these elements with the title of the web page. If any element is found to be sufficiently similar to the page title, it will be taken as TITLE ELEMENT.

In addition to the real title, the title of the web page often includes extraneous information related to the overarching website, column, and the like, which are often separated from the real title content through special delimiting characters, these characters, may include, but is not limited to, “-”, “|”, “˜”. This is additionally complicated because these separators are often not standard ASCII characters but homoglyph Unicode characters that are visually similar to ASCII characters. These may first be normalized-that is, converted into homoglyph ASCII characters-before further processing may be done.

If a part of a page title matches an element's text, the page title is divided into three portions:
1. The portion before the matched text
2. The matched text itself
3. The portion after the matched text

If the first portion is empty or ends with a delimiter, and the third portion is empty or starts with a delimiter, the element is considered the TITLE ELEMENT.

The situation becomes more complicated because the title of the web page may not exactly match the text of the title element. The differences can be due to variations in sentence patterns, word choices, or the addition of extra information. In such cases, text matching can be implemented using a similarity algorithm. For instance, an ML algorithm may be used to determine whether two sentences convey the same meaning.

It is also possible to extract the title from the title of the web page by excluding information related to the website, column, and the like, and then comparing the text of elements with the extracted title of the web page.

In one embodiment, the TITLE ELEMENT is determined based on its features. This method is hereinafter referred to as TITLE ELEMENT METHOD 7. The process may be conducted through the following steps:
1. Collect Potential Elements: Gather elements with tags that could potentially be TITLE ELEMENTs, including header tags, “div,” and similar tags.
2. Apply Constraints to Filter Elements: Evaluate each collected element against the following constraints:
   The element should be visible.
   The element's position property should not be “absolute,” “sticky,” or “fixed.”
   The distance between the top edge of the element and the top of the viewport should be within a predefined threshold.
   The width of the element should exceed a predefined threshold, such as one-third of the width of the BODY element.
   The amount of text content in the element should not exceed a predefined threshold.
   The number of descendants of the element should not exceed a predefined threshold.
   The font size of the text in the element should be larger than most of the text on the page. The font size can be determined through the following steps:
      1. Retrieve the font-family, font-size, and font-weight properties of the element.
      2. Create a <span>element (containing any character, such as ‘W’) and set its properties to those found in step 1.
      3. Measure the width and height properties of the <span>element. Defining a custom element may be helpful to prevent the created <span>element from being affected by CSS styles in the webpage.

### 3. Determine the TITLE ELEMENT

If only one element meets the constraints, it will be taken as the TITLE ELEMENT.
If more than one element meets the filter requirements, choose one element as the TITLE ELEMENT. A simple method to choose an element would be to take either the first or last element in the list.
Alternatively, the TITLE ELEMENT may be identified by comparing the text of prospective elements with the title of the web page.
Additionally, if the CONTENT ELEMENT has already been determined, the prospective element closest to the CONTENT ELEMENT may be taken as the TITLE ELEMENT.

In one embodiment, the TITLE ELEMENT is determined by identifying the header element that is closest to the CONTENT ELEMENT. If the distance between the header element and the CONTENT ELEMENT exceeds a predefined threshold, a further check is conducted. If the element between the header and the CONTENT ELEMENT is an image or a video, the header element is taken as the TITLE ELEMENT. This method is hereinafter referred to as TITLE ELEMENT METHOD 8.

Regardless of how the TITLE ELEMENT is determined, the following checks may be performed on candidates for TITLE ELEMENT to improve accuracy:
1. The element should be visible.
2. The element cannot contain more than one hyperlink.
3. The width of the element should exceed a predefined threshold.
4. The height of the element should fall within an upper and lower bound defined by two predefined thresholds.
5. The amount of text content in the element should not exceed a predefined threshold.
6. The number of descendants of the element should not exceed a predefined threshold.

In one embodiment, additional checks may be performed to reduce errors in identifying the TITLE ELEMENT. For example, an element may be excluded from consideration as the TITLE ELEMENT if its top edge is below the bottom edge of the CONTENT ELEMENT or if its left edge is further to the right of the right edge of the CONTENT ELEMENT. This method is hereinafter referred to as TITLE ELEMENT METHOD 9.

Overall, there are several ways to find the real title of a page, may include, but is not limited to:
1. exploiting knowledge about common formats of web page titles by deleting common delimiting characters and the information before or after them,
2. extracting directly from the web page title through a ML model or external service,
3. and obtaining directly from an external service which, given a URL, returns the page title format of the URL and then extracts the real title with a text matching algorithm such as regex.

### Determination of AUTHOR ELEMENT

In one embodiment, AUTHOR ELEMENT is determined by the predefined and user configured element identifier. This is analogous to CONTENT/TITLE METHOD 1. This method hereinafter is referred to as AUTHOR ELEMENT METHOD1.

In one embodiment, AUTHOR ELEMENT is determined by searching the element that matches special selectors that are known to match AUTHOR ELEMENT, may include, but is not limited to, “itemprop='author” and “.entry.entry-author”. If the web page contains only one element that matches one of these known selectors, the element is determined as AUTHOR ELEMENT. If more than one element is found, the first element found may either be taken as AUTHOR ELEMENT or as a mistake and ignored. Additional checks may be performed to ensure the accuracy of the determined AUTHOR ELEMENT, such as ensuring that it is visible and that its width and height exceed predefined thresholds. This method is analogous to CONTENT/TITLE ELEMENT METHOD2. This method hereinafter is referred to as AUTHOR ELEMENT METHOD2.

### Determination Of DATE ELEMENT

In one embodiment, DATE ELEMENT is determined by the predefined and user configured element identifier. This method is analogous to CONTENT/TITLE/AUTHOR ELEMENT METHOD1. This method hereinafter is referred to as DATE ELEMENT METHOD1.

In one embodiment, DATE ELEMENT is determined by searching for the element that matches special selectors that are known to match DATE ELEMENT, may include, but is not limited to, “itemprop=‘dateModified’”, “itemprop=‘datePublished’”, “time. datePublished”, “.article_datetime”, “.postmetadata.date”, “a[rel=author]”, “#author.authorname”, and “meta[name*=‘author’]”. If the web page contains only one element that matches one of these known selectors, the element is taken as DATE ELEMENT. If more than one element is found, the first element found may either be taken as DATE ELEMENT or as a mistake and ignored. Additional checks may be performed to ensure the accuracy of the determined DATE ELEMENT, such as ensuring that it is visible and that its width and height exceed predefined thresholds. This method is analogous to CONTENT/TITLE/AUTHOR ELEMENT METHOD2. This method hereinafter is referred to as DATE ELEMENT METHOD2.

In one embodiment, DATE ELEMENT is determined by validating that the element's text conforms to known popular first names and last names.

In one embodiment, DATE ELEMENT is determined by validating that the element's text conforms to known date formats, may including, but is not limited to, ISO 8601, DD/MM/YYYY, DD-MMM-YYYY, and Month, Day, Year.

### Determination of ORIGINAL AREA

When the elements that represent major information of web pages are determined, the area that these elements occupy is merged to generate ORIGINAL AREA. In one embodiment, ORIGINAL AREA is generated in following way:
Take the minimum value of the left of all elements as the left of the merged area.
Take the maximum value of the right of all elements as the right of the merged area.
Take minimum value of the top of all elements is used as the top of the merged area.
Take the maximum value of the bottom of all elements as the bottom of the merged area.

An element may have significant white space that does not contain any information and may be omitted. This may include padding, margins, or borders on the left, right, top, or bottom sides of the element or its child elements; or empty grid spaces if the element is laid out using a grid. In one embodiment, the white spaces of some of these elements are excluded before merging.

TITLE ELEMENT may also contain white space to its left and right. If TITLE ELEMENT does not contain any child elements, the width of its text node may be taken as its width; if TITLE ELEMENT contains exactly one child element and does not contain a text node, the left and right edges of its child may be taken as the left and right edges of TITLE ELEMENT. If TITLE ELEMENT contains several child elements, the left edge of the child element furthest to the left may be taken as the left edge of TITLE ELEMENT and the right edge of the child element furthest to the right may be taken as the right edge of TITLE ELEMENT.

Some of the four identified elements of significance may contain another, in which case the contained element does not need to participate in the merge operation. A particularly notable example of this is that CONTENT ELEMENT often contains TITLE ELEMENT.

### Determination of TARGET AREA

Users may choose TARGET AREA according to personal preferences. If the user does not, a predefined area may be taken as the default value for TARGET AREA, such as the viewport of the web page. A user interface may be created to allow users to manually select TARGET AREA by simply dragging the mouse.

In one embodiment, when fitting, padding is set around ORIGINAL AREA on the left, right, top, or bottom sides. Padding values may be set as fixed values or may be modified manually by users.

### Fitting ORIGINAL AREA to TARGET AREA

After ORIGINAL AREA is generated and TARGET AREA is selected, ORIGINAL AREA will need to be fitted to TARGET AREA. Fitting comprises two steps: zooming in, and repositioning.

Because the width of TARGET AREA is usually larger than the width of ORIGINAL AREA, ORIGINAL AREA may be enlarged to fit the width of TARGET AREA.

To zoom in, the zoom factor may first be computed. In one embodiment, the zoom factor is defined as width of TARGET AREA/width of ORIGINAL AREA. In another embodiment, the zoom factor is defined as the smaller of the horizontal zoom factor (width of TARGET AREA/width of ORIGINAL AREA) and the vertical zoom factor (height of TARGET AREA/height of ORIGINAL AREA).

A maximum zoom factor may also be set.

The zoom-in operation itself is performed on the BODY element or HTML element of the web page. Certain CSS styles may be used to perform the zoom, such as “document.body.style.scale”, “document.body.style.zoom”, “document.documentElement.style.zoom”, “document.body.style.transform”, “document.documentElement.style.transform”, and the like. Currently, JavaScript does not permit zoom-in functionality in desktop/laptop browsers without modifying the layout of the web page, such as a pinch zoom. If this functionality were supported, it would be used to implement the operation instead. The function “browser.runtime.setZoom” is capable of zooming in on a tab.

There are two different ways of zooming in using the transform CSS property:
1. Use the scale ( ) CSS function.
2. Use a combination of the perspective ( ) CSS function and the translateZ ( ) CSS function:
   a. Set translateZ as z px, where z is given by the formula z=x−x/scale and x is the value that assigned to perspective
Other possible methods for achieving zoom effects may also exist

If the ORIGINAL AREA is the same as the area occupied by CONTENT ELEMENT, the font size of the text in CONTENT ELEMENT may be increased.

The zoomed-in area may be positioned correctly by executing functions such as window.scroll, window.scrollTo, or window.scrollBy; or by modifying CSS properties of the BODY element or HTML element, such as the scrollLeft property or scrollTop property; or by calling the translate CSS function on the BODY element or HTML element if the scale CSS function was used to zoom in.

If ORIGINAL AREA is exactly the same as the area occupied by CONTENT ELEMENT, it may be positioned by calling element.scrollIntoView function.

In addition, a website may have elements with specific position property, such as “fixed” or “sticky” which may be dealt with in special ways because the presence of these elements may interfere with reading after fitting. Hiding these elements is one of these methods and may be performed in several different was, including:
setting display property to “none”
setting visible property to “hidden”
setting opacity property to 0 or a value close to 0
changing the height and/or width to 0 or a value close to 0
changing the left and top position to an extreme value. changing the foreground and background to the same color
directly removing the element

Users may be given options to choose the method with which the aforementioned elements are hidden-or whether to hide them at all-for specific pages, specific sites, or for all sites.

It is also necessary to check whether elements with the aforementioned position properties or one of their descendants is TITLE ELEMENT to avoid hiding TITLE ELEMENT. If this is the case, the position property of the element may be changed to “static”.

In one embodiment, the present disclosure employs a combination of CONTENT ELEMENT METHOD1, CONTENT ELEMENT METHOD2 and CONTENT ELEMENT METHOD3 to determine CONTENT ELEMENT and a combination of TITLE ELEMENT METHOD1, TITLE ELEMENT METHOD2 and TITLE ELEMENT METHOD3 to determine TITLE ELEMENT, hides elements with position property set to “fixed” or “sticky” and display property set to “block”, and then merges the areas of CONTENT ELEMENT and TITLE ELEMENT to generate ORIGINAL AREA, and finally fits ORIGINAL AREA to TARGET AREA using the scale ( ) CSS function and the translate ( ) CSS function on the BODY element.

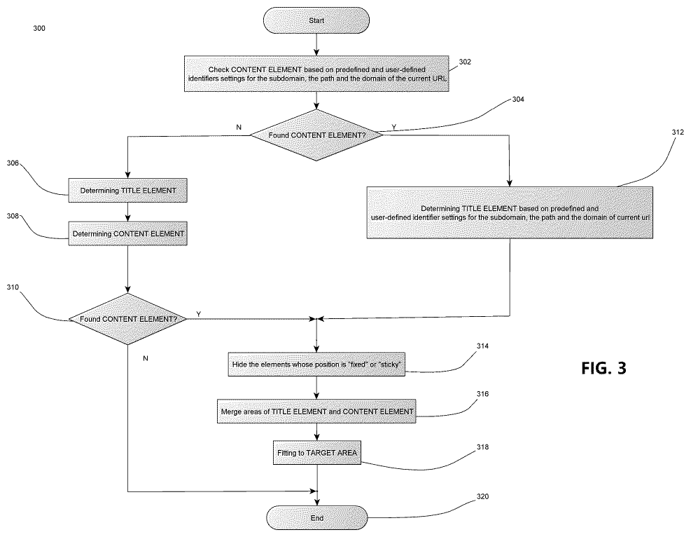

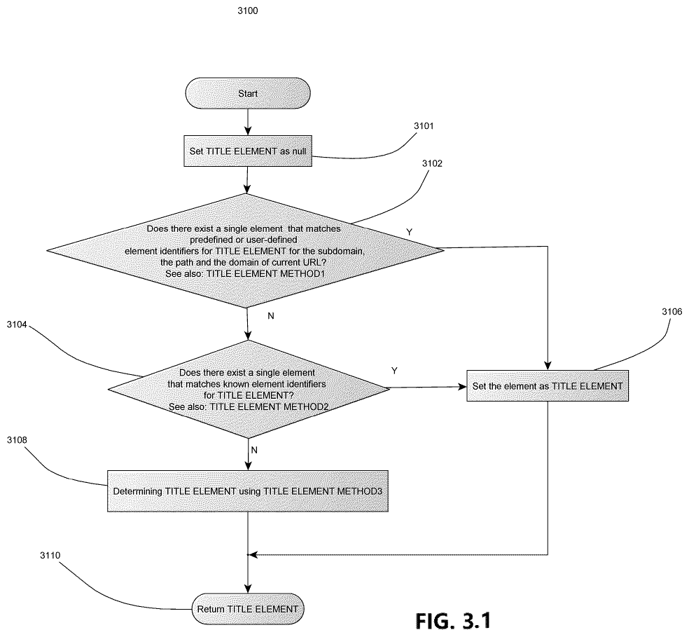

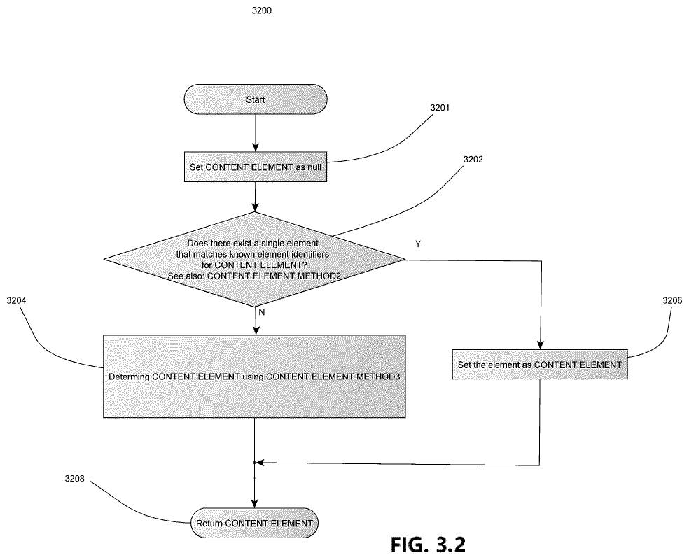

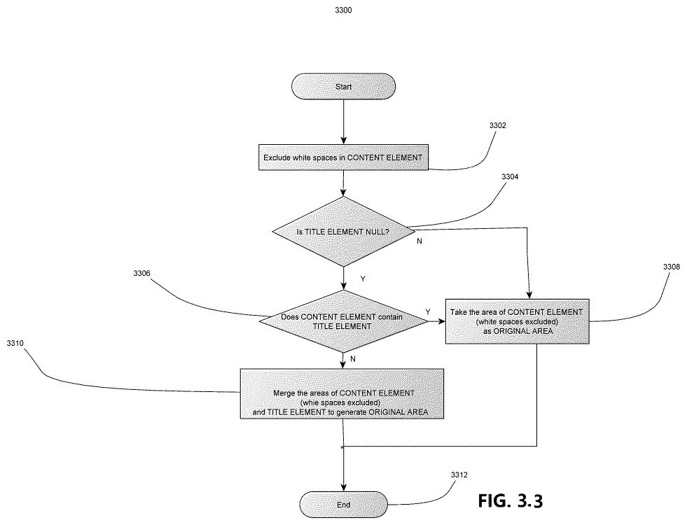

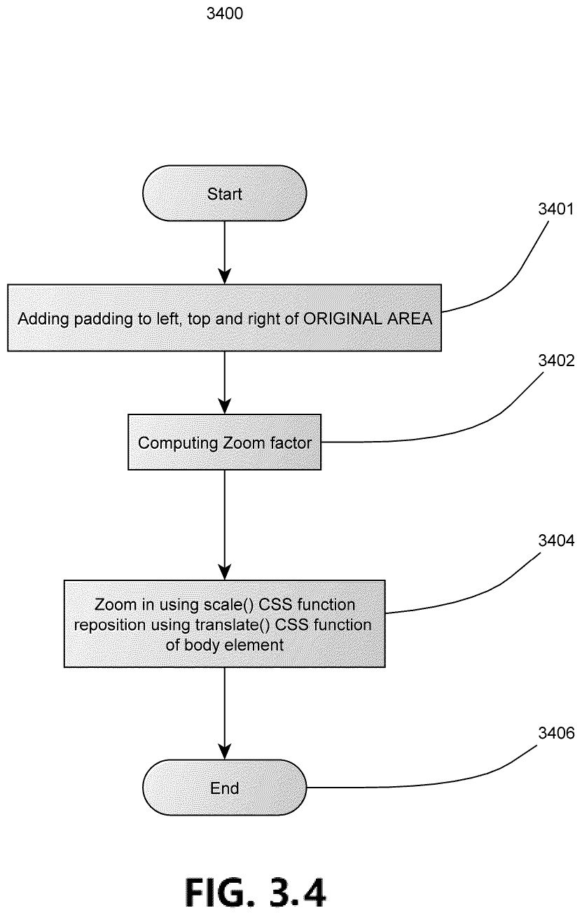

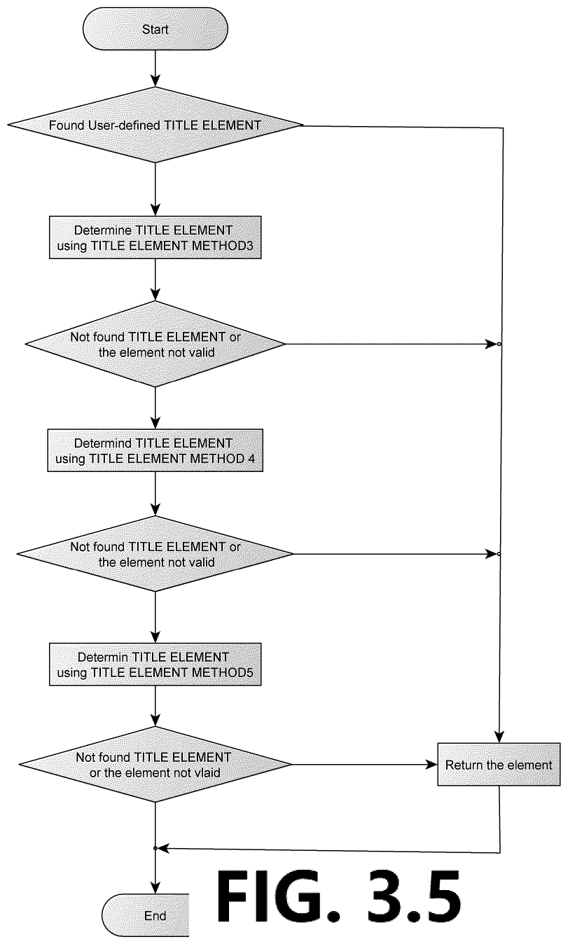

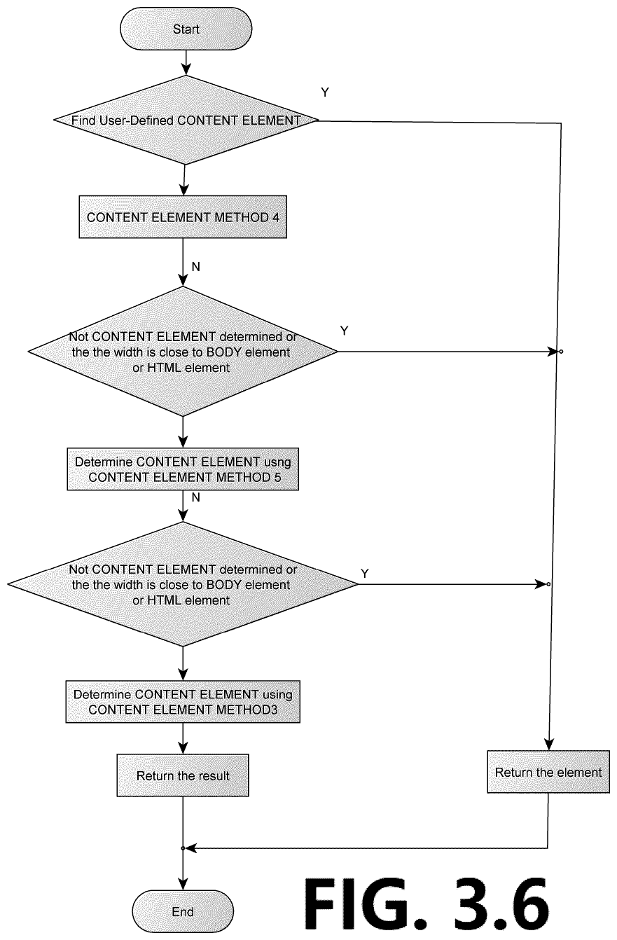

FIG. 3 is a flow diagram illustrating this embodiment. First, CONTENT ELEMENT METHOD1 is used to check whether to determine CONTENT ELEMENT based on the predefined and user-selected element identifier for the web page URL at block 302. If CONTENT ELEMENT is found, TITLE ELEMENT METHOD1 is used to determine TITLE ELEMENT. Otherwise, the process at block 306 will determine TITLE ELEMENT, and the process at block 308 will determine CONTENT ELEMENT and check whether CONTENT ELEMENT is found. If it is not found, the overall process terminates; if it is found, no matter through which method, the elements with “fixed” or “sticky” position and “block” display attributes will be hidden at block 314. Then, the areas of CONTENT ELEMENT and TITLE ELEMENT are merged to generate ORIGINAL AREA at block 316, and ORIGINAL AREA is fit to TARGET AREA at block 318.

At block 304, if CONTENT ELEMENT is determined using CONTENT ELEMENT METHOD1, TITLE ELEMENT METHOD1 is to be used to determine TITLE ELEMENT at block 312. In the embodiment, it is assumed that if users manually select CONTENT ELEMENT for a website's layout, it is very likely that the user will manually select TITLE ELEMENT as well. If no TITLE ELEMENT is selected, it is very likely either because TITLE ELEMENT is inside CONTENT ELEMENT, or no specific TITLE ELEMENT exists.

FIG. 3.1 is a flow diagram that illustrates the process in which TITLE ELEMENT is determined. Exemplary process 3100 may be performed as a part of process 300 including operations related to block 306 of FIG. 3. At block 3101, TITLE ELEMENT is set as null and TITLE ELEMENT METHOD1, TITLE ELEMENT METHOD2 and TITLE ELEMENT METHOD3 are deployed in sequence at blocks 3102, 3104 and 3108; if TITLE ELEMENT is found at any block, it will be set as TITLE ELEMENT at block 3106.

FIG. 3.2 is a flow diagram illustrating the process to determine CONTENT ELEMENT. Exemplary process 3200 may be performed as a part of process 300 including operations related to block 308 of FIG. 3. At block 3201, CONTENT ELEMENT is set as null, and CONTENT ELEMENT METHOD2 and CONTENT ELEMENT METHOD3 are deployed in sequence at blocks 3202 and 3204; if CONTENT ELEMENT is found at any block, it will be set as CONTENT ELEMENT at block 3206.

FIG. 3.3 is a flow diagram illustrating the process to generate ORIGINAL AREA. Exemplary process 3300 may be performed as a part of process 300 including operations related to block 316 of FIG. 3. At block 3302, the white space of CONTENT ELEMENT is excluded. Block 3304 checks whether TITLE ELEMENT has been found; if it has not been found, the area of CONTENT ELEMENT, with white space removed, will be regarded as TARGET AREA at block 3308. Otherwise, block 3306 will check whether CONTENT ELEMENT contains TITLE ELEMENT, in other words, whether TITLE ELEMENT is a descendant of CONTENT ELEMENT; if so, the area of TITLE ELEMENT is not considered, and the area of CONTENT ELEMENT, with white space excluded, will be regarded as TARGET AREA at block 3308. Otherwise, the areas of TITLE ELEMENT and CONTENT ELEMENT with white space removed will be merged as described earlier to generate ORIGINAL AREA at block 3310.

There are different ways to check whether CONTENT ELEMENT contains TITLE ELEMENT. In one embodiment, the full XPath of CONTENT ELEMENT and TITLE ELEMENT are generated and compared; if the XPath of TITLE ELEMENT may be found within the XPath of CONTENT ELEMENT, CONTENT ELEMENT is taken to contain TITLE ELEMENT.

This may also be accomplished by iteratively checking each ancestor of TITLE ELEMENT until either the CONTENT ELEMENT is found, in which case CONTENT ELEMENT contains TITLE ELEMENT; or BODY element is reached, in which case it does not.

If TITLE ELEMENT is a descendant of CONTENT ELEMENT, the top of ORIGINAL AREA may be taken as the top of TITLE ELEMENT.

FIG. 3.4 is a flow diagram illustrating the process to fit ORIGINAL AREA to TARGET AREA. Exemplary process 3400 may be performed as a part of process 300 including operations related to block 318 of FIG. 3. At block 3401, paddings are added to the left, right and top sides of ORIGINAL AREA to leave enough white space for the AREA. At block 3402, the zoom factor is computed as described earlier. The zoom factor is computed as:
WIDTH of TARGET AREA/(WIDTH of ORIGINAL AREA+left padding+right padding). Then, at block 3404, the scale and translate CSS functions are executed on the BODY element.

FIG. 3.5 is a flow diagram illustrating one embodiment of a process to determine the TITLE ELEMENT. This process utilizes four methods to identify the TITLE ELEMENT. If a user-selected element is found, it is regarded as the TITLE ELEMENT. If not, the process sequentially applies TITLE ELEMENT METHOD 1, TITLE ELEMENT METHOD 2, and TITLE ELEMENT METHOD 3 to identify the TITLE ELEMENT. If any of these methods determine an element, further validation may be performed to reduce the possibility of false positives

FIG. 3.6 is a flow diagram illustrating one embodiment of a process to determine the CONTENT ELEMENT. This process employs four methods to identify the CONTENT ELEMENT. If a user-selected element is found, it is regarded as the CONTENT ELEMENT. Otherwise, the process sequentially applies CONTENT ELEMENT METHOD 1, CONTENT ELEMENT METHOD 2, and CONTENT ELEMENT METHOD 3 to identify the CONTENT ELEMENT. If any of these methods determine an element, further validation may be performed to reduce the possibility of false positives.

In one embodiment, the present disclosure employs a combination of three methods to determine TITLE ELEMENT, hides elements which have a “fixed” or “sticky” position property and “block” display property, and then takes the contained within TITLE ELEMENT as ORIGINAL AREA, and finally fits ORIGINAL AREA to TARGET AREA using the scale ( ) CSS function and the translate ( ) CSS function on the BODY element.

Users may also be given the option to zoom in based solely on the title element for certain layouts

Users may also have the ability to customize behavior based on a website's framework rather than its domain. When multiple websites are built using the same framework, configuring the layout at the framework level eliminates the need to define it separately for each individual website.

In one embodiment, the present disclosure employs a combination of three methods each to determine TITLE ELEMENT, hides elements which have a “fixed” or “sticky” position property and “block” display property, and determines a portion of CONTENT ELEMENT, then combines TITLE ELEMENT and the part of CONTENT ELEMENT as ORIGINAL AREA, and finally fits ORIGINAL AREA to TARGET AREA using the scale ( ) CSS function and the translate ( ) CSS function on the BODY element.

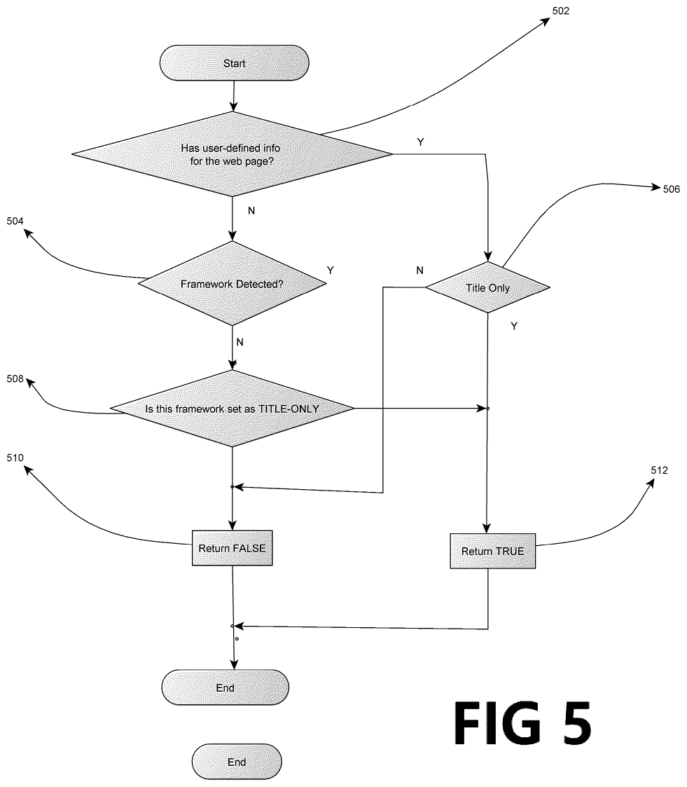

In one embodiment, the present disclosure utilizes a combination of different approaches to determine the ORIGINAL AREA. FIG. 5 is a flow diagram illustrating this embodiment.
1. First, block 502 checks if there are user-defined settings for the current webpage.
2. If user-defined settings exist, block 506 checks if the setting is configured to use only the TITLE ELEMENT to determine the ORIGINAL AREA (represented by the TITLE-ONLY variable). If it is, the process returns true; otherwise, it returns false.
3. If there are no user-defined settings for the webpage, block 504 checks if there are element selectors specific to a framework found on the webpage.
4. If such selectors exist, it is assumed that the webpage uses the corresponding framework, and the user settings for that framework are retrieved. The process then checks whether the framework is set to TITLE-ONLY and follows the same procedure as in block 506.
5. Regardless of whether webpage-specific settings or framework settings are used, if the page is TITLE-ONLY, identify the TITLE ELEMENT and consider the area it occupies as the ORIGINAL AREA.
6. If not TITLE-ONLY, identify both the TITLE ELEMENT and CONTENT ELEMENT, and merge the areas occupied by these two elements to form the ORIGINAL AREA.
7. Finally, fit the ORIGINAL AREA to the TARGET AREA

There are many alternative ways that the disclosure may be implemented:
Alternative methods or the combination of more than one method may be used to determine CONTENT ELEMENT.
Alternative methods or the combination of more than one method may be used to determine TITLE ELEMENT.
Alternative methods may be used to remove elements which have “fixed” or “sticky” position property and “block” display property, or they may be left in.
Alternative methods may be used to zoom in and reposition.
Alternative methods or the combination of more than one method may be used to exclude white spaces within elements, or they may be left in.

This disclosure may be implemented in a browser either as a browser extension or as a built-in feature within browsers.

If it is implemented as a browser extension, the analysis process may start at a different stage. Some simple web pages may only need to load a small amount of HTML and CSS code, so the operation in the disclosure may be performed when the DOMContentLoaded event occurs. However, for web pages that contain a lot of JavaScript or external resources or have complex DOM structures, it is necessary to wait for the load event to be triggered to ensure that all resources and DOM elements are fully loaded. Sometimes, even after the load event, the web page may not be fully loaded yet. In this case, the web page may be periodically analyzed after the load event to ensure that it is fully loaded, or a MutationObserver may be set up on the BODY element to start the process again on the webpage or on the new elements whenever new elements are inserted into the BODY element.

Users may be given options to choose when the process is executed-either immediately after the DOMContentLoaded event; immediately after the load event; or sometime after the load event, either by scanning periodically or using a MutationObserver to detect updates on the BODY element-for specific pages, specific sites, or all sites.

If this feature is implemented as a built-in browser function or if a zoom-in function similar to pinch-zoom in JavaScript is supported in the future, and zooming in does not alter the layout of web pages, then hiding elements with “fixed” or “sticky” position properties may not be necessary. Additionally, it may no longer be required to wait for the webpage to fully load; instead, analysis could begin during the rendering process. If the required elements have already been identified, such as through predefined or user-defined elements, or if known selectors have been detected, zooming in and repositioning can be applied according to the CONTENT METHOD 1, CONTENT METHOD 2, TITLE METHOD 1, TITLE METHOD 2.

In one embodiment, the browser performs real-time content analysis during the rendering process and utilizes a large language model (LLM) to identify the main information elements of the web page (such as the title, content, date, and author). These main elements are then adapted to fit a user-specified target area (TARGET AREA) while maintaining the original layout and styles of the web page, thus providing a more focused and streamlined reading experience.

In one embodiment, the browser can complete rendering within the content (similar to headless mode) and then use different methods to identify the main elements. These main elements are then adapted to fit a user-specified target area (TARGET AREA), preserving the original layout and styles of the web page, thus providing a more focused and streamlined reading experience.

This disclosure may be implemented in either a manual or automatic mode.

In manual mode, the user can trigger the operation for each webpage they open. If the implementation is a built-in browser feature, an indicator may be displayed in areas such as the Omnibox or Awesome Bar. The operation may start when the user clicks on this indicator. Additionally, a context menu item, a gesture, or a shortcut key may be created to trigger the operation. If implemented as a browser extension, the operation may be triggered by clicking on the extension icon, pressing a shortcut key, clicking on a context menu item, performing a gesture, or similar actions.

In automatic mode, the operation starts automatically when specific conditions are met. This requires no user action to execute operation during the webpage loading process. If it is implemented as a built-in browser feature, it will monitor the appearing elements for predefined or user-selected elements or for elements which match known selectors and begin operation either when the page has loaded or periodically after the page loaded. If it is implemented as a browser extension, the extension will begin the process after the DOMContentLoaded event, the load event, periodically after the load event, or a MutationObserver may be set up on the BODY element to execute on the web page or on the new elements whenever new elements are inserted into the BODY element.

Users may be given options to allow the user to select between manual or automatic mode for specific pages, specific sites, or all sites.

### Determination of MAIN ELEMENT in High Resolution Viewpoint

Many of the methods described involve the use of predefined thresholds that may need to be adjusted for different viewport resolutions. However, in some cases, the appropriate values for certain predefined thresholds may not depend on the resolution of the viewport. When the resolution of a webpage is high, the main components of the webpage are often positioned in the center of the viewport, with blank spaces to the left and right. The element containing the main components of the webpage, excluding the surrounding blank space, is referred to as the MAIN ELEMENT.

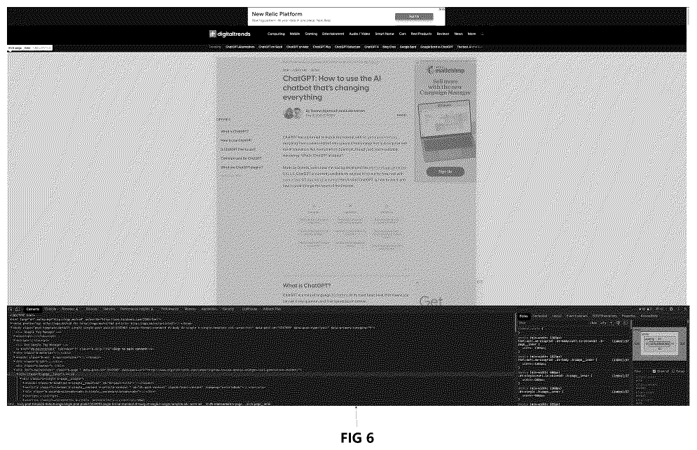

FIG. 6 illustrates an example of a webpage in a high-resolution viewport. In this case, the element “div.b-page_inner” is identified as the MAIN ELEMENT.

The MAIN ELEMENT of a web page is determined through the following steps:
1. Locate a point within the content of the webpage.
2. Retrieve the list of elements that contain the point.
3. Iterate through the list of elements from smallest to largest and examine each one until an element's left and right positions are very close to the left and right positions of the BODY element or the HTML element. The elements preceding this element in the list are considered part of the MAIN ELEMENT, and the element itself is identified as the MAIN ELEMENT.

If the MAIN ELEMENT is found, predefined thresholds may be adjusted relative to the MAIN ELEMENT instead of the BODY element or HTML element. For example, when determining the CONTENT ELEMENT using CONTENT ELEMENT METHOD 5, the minimum width of one-third of the width of the BODY or HTML element can be replaced with one-third of the width of the MAIN ELEMENT.

1. A method of displaying major content of web pages, comprising:
Determining the most significant portion of a web page, including identifying one or more of a title element, a content element, an author element, and a date element,
Generating an original area by merging the areas occupied by the identified elements,.
Fitting the original area to a user-preferable size and location by zooming in and repositioning.

2. The method of claim 1, wherein:
The title element is determined by predefined and user-configured element identifiers.

3. The method of claim 1, wherein:
The content element is determined by predefined and user-configured element identifiers.

4. The method of claim 1, wherein:
The title element is determined by known selector matching.

5. The method of claim 1, wherein:
The content element is determined by known selector matching.

6. The method of claim 1, wherein:
The title element is determined using external services or machine learning models.

7. The method of claim 1, wherein:
The content element is determined using external services or machine learning models.

8. The method of claim 1, wherein:
The title element is determined by comparing the text of elements with the title of the web page.

9. The method of claim 1, wherein:
The content element is determined by comparing the length of the text within the element to the length of all text on the page.

10. The method of claim 1, wherein:
The content element is determined according to the proportion of the occupied area of the element.

11. The method of claim 1, further comprising:
Excluding whitespace within the original area before merging.

12. The method of claim 1, wherein:
The target area is a user-selected area.

13. The method of claim 1, wherein:
The target area is a predefined area such as the viewport.

14. The method of claim 1, wherein:
Users can select the target area by dragging the mouse.

15. The method of claim 1, further comprising:
Providing options for users to choose between manual and automatic mode for the process.

16. The method of claim 1, wherein:
In automatic mode, the process starts automatically when specific conditions are met.

17. The method of claim 1, wherein:
In manual mode, the process is triggered by user interaction such as clicking a button or using a shortcut key.

18. The method of claim 1, wherein:
The zooming in and repositioning are performed to make the major content visible within the target area.

19. The method of claim 1, wherein:
The process excludes distracting elements such as ads and navigation menus.

20. The method of claim 1, further comprising:
Allowing users to manually adjust the zoom level and position of the major content within the target area.
